(19) United States
(12) Patent Application Publication
(10) Pub. No.: US 2026/0218091 A1
(43) Pub. Date: Jul. 30, 2026

(54) LOW VOLATILITY SHELLAC CLEANER COMPOSITION AND METHOD

(71) Applicant: SolvChem, Inc., Pearland, TX (US)

(72) Inventors: Jean-Pierre BAIZAN, Pearland, TX (US); Chris MATHERNE, Pearland, TX (US); Mark VORDERBRUGGEN, Pearland, TX (US); Chris JOHNSON, Pearland, TX (US)

(21) Appl. No.: 19/444,455

(22) Filed: Jan. 9, 2026

Related U.S. Application Data
(60) Provisional application No. 63/743,360, filed on Jan. 9, 2025.

(51) Int. Cl. C11D 7/26

(52) U.S. Cl. CPC C11D 7/263; C11D 7/261; C11D 2111/14; C11D 2111/44

(57) ABSTRACT

A cleaning composition is formed of a glycol ether and an ethylene glycol mixed with the glycol ether. The glycol ether is dipropylene glycol n-butyl ether. The dipropylene glycol n-butyl ether is mixed with the ethylene glycol in a 50%/50% weight percent. The cleaning composition can be applied to a tool that is used to apply or remove shellac. This tool can be a brush, a hose, a roller or a sprayer.

### CROSS-REFERENCE TO RELATED APPLICATIONS

The present application claims priority to U.S. Provisional Application No. 63/743,360, filed on Jan. 9, 2025.

### FIELD OF THE INVENTION

The present invention relates to compositions and methods that are used to clean tools that are used to apply or remove shellac from other objects. More particularly, the present invention relates to shellac cleaning solutions having low volatility.

### BACKGROUND OF THE INVENTION

Shellac is a resin secreted by the female lac bug on trees in the forest of India and Thailand. Chemically, shellac is mainly composed of aleuritic acid, jalaric acid, shelloic acid and other natural waxes. It is processed and sold as dry flakes and dissolved in alcohol to make liquid shellac. This liquid shellac is used as a brush-on colorant, food, glaze and wood finish. Shellac functions as a top natural primer, sanding sealant, tannin-blocker, odor-blocker and high-gloss varnish.

Shellac is a natural bioadhesive polymer and is chemically similar to synthetic polymers. As such, it can be considered as a natural form of plastic. Since shellac has a melting point of 75° C., it can be classified as a thermoplastic used to bind wood flour in which the mixture can be molded with heat and pressure. Shellac is soluble in alkaline solutions of ammonia, sodium borate, sodium carbonate, and sodium hydroxide. When dissolved in alcohol (typically denatured ethanol), shellac yields a coating of good durability and hardness.

Shellac is a valuable material that can be applied by brushes, with hoses, with rollers or by air-driven sprayers. Whenever shellac is added to an object, it is important to be able to remove the shellac from the tool. This process can be quite difficult and involves the use of volatile chemicals by consumers and businesses.

To fight air pollution and improve air quality, numerous cities, counties and states have banned the use of these volatile chemicals. The basic definition of a “volatile chemical” is one that chemically transitions from a liquid form to a gaseous form due to a high vapor pressure at standard temperature and pressure conditions. Examples of common volatile chemicals include, but are not limited to, formaldehyde, benzene, toluene, limonene and ethyl alcohol. California, Delaware, New Hampshire, Connecticut, Rhode Island, Maryland, Utah, Colorado, New York, Michigan, and Ohio have passed laws banning the use of these volatile chemicals. This forces consumers and businesses to find volatile chemical compliant replacements.

One of the most difficult products to replace is denatured alcohol. Denatured alcohol is extremely necessary for the purpose of cleaning painting equipment used when applying shellac. The importance of using shellac as a surface coating cannot be understated. Shellac is the only coating which will effectively seal in cigarette smoke and tar on apartment walls, water stains, pine pitch, and other common items which bleed through coatings and therefore ruin other types of paint.

In those circumstances where denatured alcohol cannot be used because of legal prohibitions, this forces the premature discarding of the tools and equipment after use with shellac. Another issue is having to repaint surfaces with many extra layers because the stains bleed through easier. The additional repeated paintings result in more chemicals overall entering the environment and significantly higher costs to everyone.

The current replacement for cleaning up after painting with shellac that is compliant with the laws is a 50/50 (volume) mixture of water and household ammonia. This mixture does remove shellac, but it damages the brushes and rollers. The ammonia fumes can be extremely painful to the painter as well as other humans or animals in the vicinity of the use of such ammonia. The inhalation of the ammonia fumes could result in serious health issues.

Water, mineral spirits, acetone and other common paint removers do not clean shellac off equipment or are also banned under state-mandated volatile chemical rules. As such, there is a need for low volatility shellac cleaning compositions in order to replace denatured alcohol and/or the water/ammonium mix.

In the past, various patents and patent application publications have issued with respect to such cleaning solutions. For example, U.S. Pat. No. 3,075,923, issued on Jan. 29, 1963 to Berst et al., shows a finish remover composition. This finish remover composition consists essentially of methylene chloride and a minor proportion, sufficient to improve the finish stripping ability of said remover, of a sulfonic acid selected from the group consisting of benzene sulfonic acid, alkyl benzene sulfonic acids in which the alkyl groups contain a total of from 1 to about 18 carbon atoms per molecule, and mixtures thereof.

U.S. Pat. No. 5,006,279, issued on Apr. 9, 1991 to Grobbel et al., describes a water-based coating remover that comprises a substantially stable and homogenous mixture of N-methyl-2-pyrrolidone, a mononuclear aromatic hydrocarbon, a glycol ether, an alkanolamine and a hydroxypropyl cellulose thickener.

U.S. Pat. No. 6,482,270, issued on Nov. 19, 2002 to Machac et al., describes a paint and coating remover that includes a carbonate, a dibasic ester and a mono-ester. The composition may also contain an organic sulfur-containing compound such as dimethyl sulfoxide (DMSO), a glycol ether, a ketone, or combination thereof. The composition may be used in a process for removing paint by applying it to a painted surface. The compositions have several important attributes, including low toxicity and high efficacy in removing paint and coatings.

U.S. Pat. No. 8,865,636, issued on Oct. 21, 2014 to Han et al., discloses a paint stripping composition that comprises dichloroethylene, aromatic alcohols and ethers, surfactants, corrosion inhibitors, thickeners, wax solvents and water. This paint stripping composition is particularly useful in stripping paint and other polymeric coatings from metal substrates such as aluminum and its alloys.

U.S. Patent Application Publication No. 2014/0274855, published on Sep. 18, 2014 to Shumann et al., provides a composition for removing color coats from surfaces. This composition comprises a microemulsion or a fluid nanophase system, and has the following components: a) at least one non-water-soluble substance having a solubility in water of less than 4 g per liter, b) at least one amphiphile substance, NP-MCA, that has no tenside structure, does not form structures on its own, has a solubility in water or oil between 4 g and 1000 g per liter, and preferably does not accumulate at the oil-water boundary, with the provision that NP-MCA is not selected from among 2-Ethyl-1,3-Hexanediol, 2-Methyl-2,4-Pentanediol, 2-(n-Butyl)-2-Ethyl-1,3-Propanediol and/or 1,2-Diols; c) at least one anionic, cationic, amphoteric and/or non-ionic tenside; d) water and/or a water-soluble solvent having hydroxyl functionality and, optionally, additives.

U.S. Patent Application Publication No. 2021/0054219, published on Feb. 25, 2021 to G. Morose, shows a composition and method for removing a coating from a surface. This composition includes a first solvent selected from methyl acetate, dimethyl carbonate, acetone, or a combination thereof, a second solvent selected from thiophene, 1,3-dioxolane, thioacetic acid, or a combination thereof, and, optionally, a third solvent selected from dimethyl sulfoxide, methyl glyoxal, propylene carbonate, gamma butyrolactone, ethylene carbonate, 2-chloro-1-propanol, methanol, ethanol, ethylene glycol, propylene glycol, 1-propanol, 2-propanol, or a combination thereof. The respective amounts of each solvent are further described herein, and the total amounts of the first solvent, the second solvent, and the third solvent sum to at least 90 volume percent of the total volume of the composition. The composition can be particularly useful for removal of a coating from a surface. Accordingly, a method of removing a coating from a surface is also disclosed.

It is an object of the present invention to provide a shellac cleaner composition that avoids the use of denatured alcohol.

It is another object of the present invention to provide a shellac cleaner composition that effectively cleans tools used for the application and removal of shellac.

It is another object of the present invention to provide a shellac cleaner composition that has low volatility.

It is another object of the present invention to provide a shellac cleaner composition that avoids the premature discarding of equipment, such as brushes, rollers, hoses, and air-driven sprayers.

It is another object of the present invention to provide a shellac cleaner composition that reduces the volume of chemicals that enter the environment.

It is still another object of the present invention to provide a shellac cleaner composition that reduces the cost of shellac application and removal.

It is another object of the present invention to provide a shellac cleaner composition that is in compliance with state regulatory laws on VOCs.

It is another object of the present invention to provide a shellac cleaner composition that avoids the use of ammonium/water mixtures and the vapors associated therewith.

It is another object of the present invention to provide a shellac cleaner composition that avoids toxic fumes.

It is still another object of the present invention to provide a shellac cleaner composition that eliminates or reduces health issues.

It is still a further object of the present invention to provide a shellac cleaner composition that has only two or three components.

These and other objects and advantages of the present invention will become apparent from a reading of the attached specification and appended claims.

### SUMMARY OF THE INVENTION

The present invention is a cleaning composition for the removal of shellac from tools. This cleaning composition is a mixture of glycol ether and ethylene glycol. The glycol ether is dipropylene glycol n-butyl ether. The dipropylene glycol n-butyl ether is approximately 50 weight percent of the entire mixture. The ethylene glycol is approximately 50 weight percent of the entire composition. As such, the dipropylene glycol n-butyl ether is mixed in a 50-50 ratio with the ethylene glycol. The dipropylene glycol n-butyl ether has a density of approximately 0.9 g/mL. The ethylene glycol has a density of approximately 1.1 g/mL. The dipropylene glycol n-butyl ether has the following chemical formula:

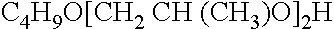

This cleaning composition is to be applied to a tool used to apply or remove the shellac. As such, it is intended to remove residual shellac from the tools effectively and efficiently. The tool can be one of a brush, a hose, a roller or a sprayer. After application, the cleaning composition can be rinsed from the tool.

The present invention is also a method of removing shellac from tools. This method includes the steps of: (1) forming a mixture of a glycol ether and ethylene glycol; (2) applying the formed mixture to the surface of the tool; and (3) rinsing the applied mixture from the tool.

In this method, the glycol ether is dipropylene glycol n-butyl ether. The glycol ether and the ethylene glycol is mixed in a 50/50 ratio. The glycol ether is sold under the trade not in DOWANOL DPnB™. The mixture includes only the glycol ether and the ethylene glycol. The step of rinsing includes applying water to a surface of the tool that has the mixture thereon. As such, the water is used so as to remove the mixture of the glycol ether and the ethylene glycol from the tool.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### DETAILED DESCRIPTION OF THE INVENTION

The present invention is a cleaning composition for removing glycol ether from tools. These tools have been particularly used for the application of shellac onto other objects or the removal of shellac from such objects. As such, the goal of the cleaning composition of the present invention is to effectively remove the shellac from the tools with a low volatility formula.

After experiments with the present invention, it was found that the composition of a glycol ether with an ethylene glycol was effective at removing the shellac from the tools. In particular, the following table shows this mixture:

TABLE I

| Formula | Date | | | Density | % |
|---|---|---|---|---|---|
| Code | Formulated | Component | CAS # | g/ml | Weight |
| LVST- | May 9, 2024 | Dipropylene | 29911-28-2 | 0.913 | 50.00 |
| B-0021 | | Glycol | | | |
| | | Mono N-Butyl | | | |
| | | Ether** | | | |
| | | Ethylene | 107-21-1 | 1.1132 | 50.00 |
| | | Glycol | | | |

The glycol ether is, in particular, dipropylene glycol n-butyl ether. This is sold under the tradename “DOWANOL DPnB” by Dow Chemical Company. This is represented by the following formula:

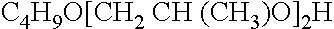

This dipropylene glycol n-butyl ether is a slow-evaporating, hydrophobic glycol ether with excellent surface tensioning-lowering ability and coalescing properties. This dipropylene glycol n-butyl ether is a relatively slow-evaporating solvent and is very efficient as a coalescent, in water-born latex systems.

As can be seen from the above Table I, the dipropylene glycol n-butyl ether has a 50 weight percent of the composition and the ethylene glycol has a 50 weight percent of the composition. The density of the dipropylene glycol n-butyl ether is approximately 0.9 g/mL. The ethylene glycol has a density of approximately 1.1 g/mL.

This formulation was reviewed for negative issues such as overly toxic solvents, bad odors, skin irritation, and other harmful or undesirable components. This two-component blend was found to be effective in its ability to clean both wet and dried shellac from paint brushes, paint sprayers, rollers, and other items. The application of this composition was compared with denatured alcohol and the water/ammonia mix.

In most cases, the present composition matched or exceeded the performance of the other cleaning agents. In particular, the brush hairs remained more pliant when cleaned with the composition of the present invention. However, the composition of the present invention did require approximately 15% more volume than that required by denatured alcohol in order to clean out a paint sprayer system. In any event, it effectively avoided any fumes that would be produced by the ammonia/water mix. As such, the combination of a dipropylene glycol n-butyl ether with the ethylene glycol achieved a product that was very effective at removing shellac from these various tools in a safe, efficient and effective manner.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

1. A cleaning composition comprising:
a glycol ether; and
an ethylene glycol mixed with the glycol ether.

2. The cleaning composition of claim 1, wherein the glycol ether is dipropylene glycol n-butyl ether.

3. The cleaning composition of claim 2, wherein the dipropylene glycol n-butyl ether has an approximately 50% weight percent of the total composition, the ethylene glycol has approximately 50% weight percent of the cleaning composition.

4. The cleaning composition of claim 3, wherein the dipropylene glycol n-butyl ether has a density of approximately 0.9 g/mL, the ethylene glycol has a density of approximately 1.1 g/mL.

5. The cleaning composition of claim 4, the dipropylene glycol n-butyl ether has a chemical formula of C₄H₉O[CH₂ CH (CH₃)O]₂H.

6. The cleaning composition of claim 1, wherein the cleaning composition is to be applied to tools that were used to apply or remove shellac.

7. The cleaning composition of claim 6, wherein the tools are selected from the group consisting of a brush, a hose, a roller and a sprayer.

8. A cleaning composition consisting of:
dipropylene glycol n-butyl ether; and
an ethylene glycol mixed with the dipropylene glycol n-butyl ether.

9. The cleaning composition of claim 8, wherein the dipropylene glycol n-butyl ether has an approximately 50% weight percent, the ethylene glycol has an approximately 50% weight percent of the cleaning composition.

10. The cleaning composition of claim 8, wherein the dipropylene glycol n-butyl ether is sold under the tradename of DOWANOL DpnB™.

11. A method of removing shellac from tools, the method comprising:
forming a mixture of a glycol ether and an ethylene glycol;
applying the formed mixture to a surface of the tool; and
rinsing the applied mixture from the tool.

12. The method of claim 11, wherein the glycol ether is dipropylene glycol n-butyl ether.

13. The method of claim 11, wherein the mixture of the glycol ether and the ethylene glycol is approximately 50% by weight of the glycol ether and approximately 50% by weight of the ethylene glycol.

14. The method of claim 12, wherein the dipropylene glycol n-butyl ether has a density of approximately 0.9 g/mL, the ethylene glycol having a density of approximately 1.1 g/mL.

15. The method of claim 11, the dipropylene glycol n-butyl ether having the chemical formula of:

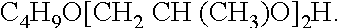

16. The method of claim 11, wherein the tool is selected from the group consisting of a brush, a hose, a roller and a sprayer.

17. The method of claim 16, wherein the mixture consists only of the glycol ether and the ethylene glycol.

18. The method of claim 11, wherein the step of rinsing comprising supply water to the surface of the tool that has the mixture thereon.

19. The method of claim 11, wherein the glycol ether is sold under the trademark DOWANOL DPnB™.
